(19) United States
(12) Patent Application Publication
(10) Pub. No.: US 2009/0265248 A1
(43) Pub. Date: Oct. 22, 2009

(54) Virtual Concierge for Shipping Services

(76) Inventor: Deborah Walker, Los Angeles, CA (US)

Correspondence Address: Reed Smith LLP, p.o. box 488, pittsburgh, PA, 15230, US

(21) Appl. No.: 12/428,466

(22) Filed: Apr. 22, 2009

Related U.S. Application Data
(60) Provisional application No. 61/046,858, filed on Apr. 22, 2008.

(51) Int. Cl. G06Q 50/00; G06F 17/00; G06Q 20/00; G06Q 30/00; G07B 17/02; G06F 3/048

(52) U.S. Cl. 705/17; 700/231; 705/21; 705/27; 705/407; 705/408; 705/411; 715/760; 715/780

(57) ABSTRACT

A virtual concierge for shipping services is disclosed. One aspect of certain embodiments includes providing an automated computer-implemented self-service front-end shipping system to business concerns for self-service access by the customers of the respective business concern for shipping the customer's packages.

### CROSS REFERENCE TO THE INVENTION

This application claims the benefit of U.S. Provisional Application No. 61/046,858 filed Apr. 22, 2008, entitled “A Self-Service Parcel Shipping Center”, the disclosure of which is herein incorporated by reference.

### TECHNICAL FIELD

The disclosed embodiments relate generally to computerized services. More. particularly, the disclosed embodiments relate to methods, systems, and user interfaces that provide automated self-service shipping services to customers.

### BACKGROUND

Business concerns such as those in the hospitality and travel industry provide full service concierge services for customers, such as hotel guests and convention attendees. Such full-service concierge services may or may not include shipping services. One problem is that full-service concierge services of any kind are expensive and require significant staffing. Another problem is that even if the full-service concierge service includes shipping services, there is no cost-effective automated way for the concierge staff to ship packages for hotel guests, for example. In other words, one or more of the concierge staff members need to take the packages to a shipping carrier location for weighing the packages and paying for the shipping charges. The full-service concierge service must then bill the hotel guest for the shipping charges. Worse yet, when concierge services do not include shipping services, as is often the case, it is up to the hotel guest or convention attendee to obtain and complete shipping forms, obtain packaging supplies and request assistance from hotel staff to make pick-up arrangements.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating a distributed computer system 100, according to certain embodiments.

FIG. 2 is a high-level flowchart representing some of the steps for using the virtual concierge shipping system, according to certain embodiments.

FIGS. 3A-3H are screen shots that illustrate graphical user interface 103 and concomitant sample web pages, according to certain embodiments.

### DESCRIPTION OF EMBODIMENTS

Methods, systems, user interfaces, and other aspects of the invention are described. Reference will be made to certain embodiments, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, a virtual concierge for shipping services is provided to businesses as a cost-effective solution that can be offered as a value added service to customers of those businesses. Examples of such business concerns include those in the hospitality and travel industry, as well as convention planners. Such a virtual concierge not only enhances the existing services that the business concern can provide to its clientele but can be a source of revenue for the business concern rather than a cost center.

According to certain embodiments, the virtual concierge comprises an automated self-service front-end shipping system that customers can access at their convenience, 24/7. Further, the customers do not need an account with any of the shipping carriers when using the automated self-service front-end shipping system. For example, a hotel guest may want to ship packages or luggage to a desired destination. Rather than having to obtain and complete shipping forms and packaging supplies in addition to requesting assistance from hotel staff to make payment and pick-up arrangements, the hotel guest can use the easy-to-use automated self-service front-end shipping system to ship packages or luggage to a desired destination.

According to certain embodiments, the automated self-service front-end shipping system provides access to a web based computer application that allows the customer to select a shipping carrier, select a class of shipping service, specify destination information, receive pricing information and further allows the customer to pay for the shipping service using a convenient form of payment. The automated self-service front-end shipping system also allows the customer to obtain and pay for packaging materials such as boxes and envelopes. According to one aspect of certain embodiments, the automated self-service front-end shipping system provides a graphical user interface to allow the customer to input shipping and payment information. According to another aspect of certain embodiments, the automated self-service front-end shipping system creates a prepaid encoded shipping label based on the information that the customer inputted into the system using the graphical user interface.

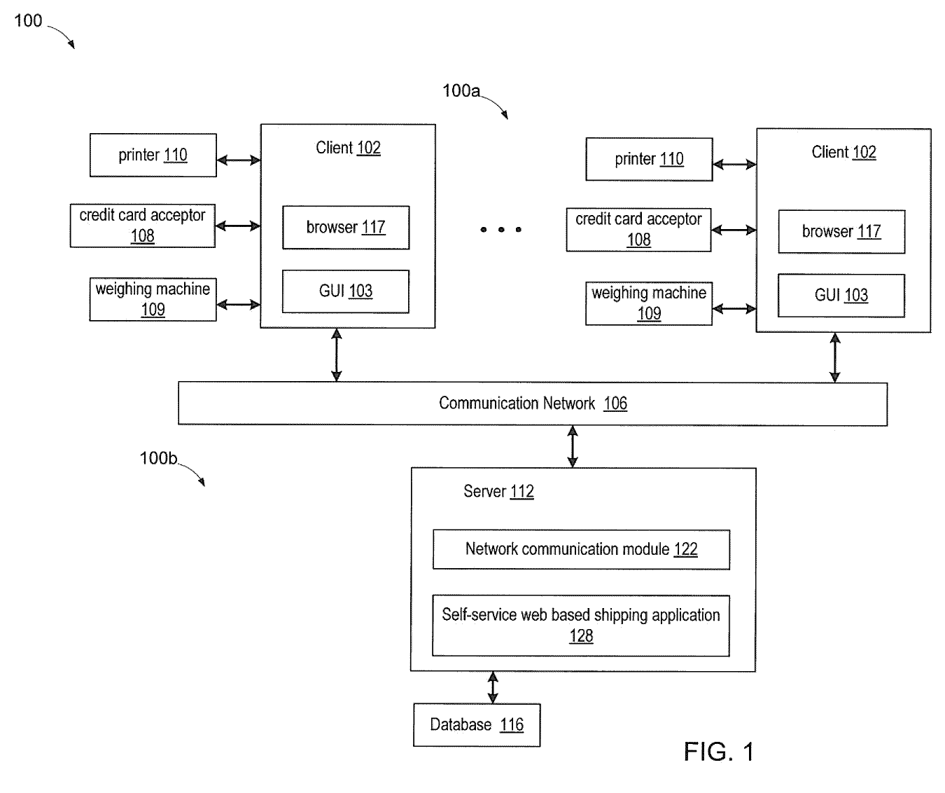

FIG. 1 is a block diagram illustrating a distributed computer system 100, according to certain embodiments. In FIG. 1, a virtual concierge for shipping system 100 may include an automated self-service front-end shipping system 100a and a back-end shipping system 100b.

According to some embodiments, automated self-service front-end shipping system 100a may include one or more client computers 102, output devices 110 (e.g., printer), input devices (not shown) and may optionally include a credit card acceptor machines 108 and automated weighing machines 109 (also optional).

According to certain embodiments, back-end shipping system 100b may include one or more distributed servers 112 and one or more databases 116. Automated self-service front-end shipping system 100a and back-end shipping system 100b can communicate through communications network 106.

Client computers 102 can be any of a number of computing devices (e.g., Internet kiosk, personal digital assistant, cell phone, gaming device, desktop computer, laptop computer, handheld computer, interactive TV system or combinations thereof) used to enable the activities described below. Client computer(s) 102 is also referred to herein as client(s). Input devices can be any of a number of devices such as a mouse, keyboard, touch screen, track ball and microphone. Client 102 may include a graphical user interface (GUI) 103 and a web browser 117. Optionally, client 102 may include application interface(s) and driver(s) for credit card acceptor machines 108 and automated weighing machines 109.

According to some embodiments, server 112 includes a network communications module 122, and a self-service web based shipping application 128. The network communications module 122 connects server 112 to the communication network 106 and enables the receipt of communications from the communication network 106 and the provision of communications to the communication network 106 bound for client 102 or other destinations. Server 112 communicates with databases such as databases 116 via network communication module 122. Server 112 may manage payment information, customer information, and shipping carrier information. According to some embodiments, self-service web based shipping application 128, presents web pages on client 102 to a customer to allow the customer to select a shipping carrier from a variety of carriers, select shipping options, enter shipment information, and make payments for selected services. Self-service web based shipping application 128 may also gather and manage customer profile information.

In the case of multiple servers, each server, such as server 112, is coupled to a communications network 106 (wireless or wired) via a network communication module 122. The communications network 106 may be the Internet, but may also be any local area network (LAN) and/or wide area network (WAN). In some embodiments, server 112 is a Web server. Alternatively, if server 112 is used within an intranet, it may be an intranet server.

In essence, server 112 is configured to manage certain aspects of virtual concierge shipping system 100, including receiving and managing requests from the customer (associated with client 102), sending messages to client 102, sending information for display on client 102 and requesting information from client 102.

In some embodiments, fewer and/or additional modules, functions or databases are included in virtual concierge shipping system 100. The modules shown in virtual concierge shipping system 100 represent functions performed in a certain embodiments.

Notwithstanding the discrete blocks in FIG. 1, the figure is intended to be a functional description of some embodiments rather than a structural description of functional elements in the embodiments. One of ordinary skill in the art will recognize that an actual implementation might have the functional elements grouped or split among various components. For example, database 116 may be part of server 112. In some embodiments, database 116 may be implemented using one or more servers whose primary function is to store customer shipping information. Moreover, one or more of the blocks in FIG. 1 may be implemented on one or more servers designed to provide the described functionality. Although the description herein refers to certain features implemented in client 102 and certain features implemented in server 112, the embodiments are not limited to such distinctions. For example, features described herein as being part of server 112 could be implemented in whole or in part in client 102, and vice versa.

The above identified modules and applications in FIG. 1 correspond to a set of instructions for performing one or more functions described herein. These modules (sets of instructions) need not be implemented as separate software programs, procedures or modules, and thus various subsets of these modules may be combined or otherwise re-arranged in various embodiments.

In practice, and as recognized by those of ordinary skill in the art, items shown separately could be combined and some items could be separated. For example, some items shown separately in FIG. 1 could be implemented on a single server and single items could be implemented by one or more servers. As another example, the databases may be separated into more granular components. The actual number of servers in the virtual concierge shipping system 100 and how features are allocated among them may vary from implementation to implementation.

Further, certain components and networks that are well known to those of ordinary skill in the art are not described in detail in FIG. 1 to avoid obscuring aspects of the present invention. FIG. 1 may include one or more processing units (CPU's), one or more network or other communications interfaces, memory, an operating system that includes procedures for handling various basic system services and for performing hardware dependent tasks, and one or more communication buses for interconnecting these components. The communication buses may include circuitry (sometimes called a chipset) that interconnects and controls communications between system components. Memory may include high speed random access memory and may also include non-volatile memory, such as one or more magnetic or optical disk storage devices. Memory may optionally include one or more storage devices remotely located from the CPU(s).

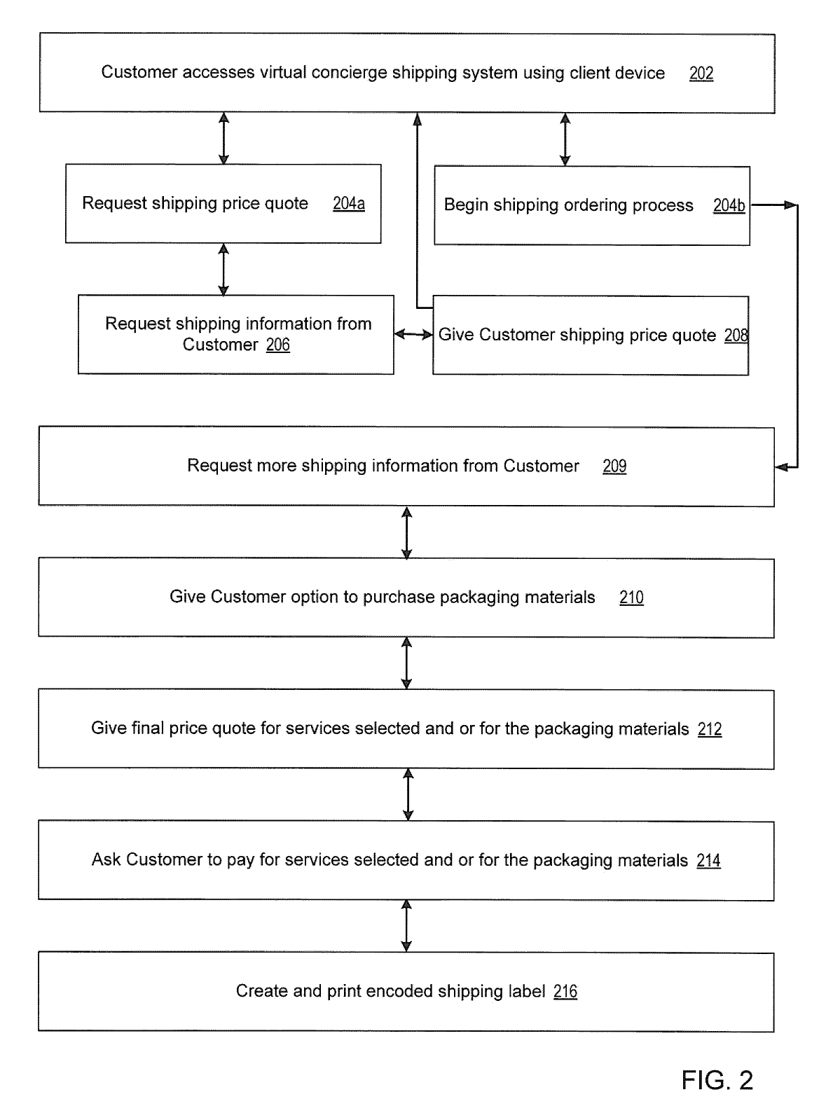

FIG. 2 is a high-level flowchart representing some of the steps for using the virtual concierge shipping system, according to certain embodiments. A customer (“Customer”), such as a hotel guest that wishes to ship packages or luggage, accesses the virtual concierge shipping system by using automated self-service front-end shipping system 100a.

For purposes of illustration, the virtual concierge system will be described in the context of a web-based program. However, the embodiments are not limited to web-based programs and thus may vary from implementation to implementation.

In block 202 of FIG. 2, Customer accesses virtual concierge shipping system using client 102. According to certain embodiments, automated self-service front-end shipping system 100a is activated when Customer presses any key on an input device associated with client 102 or uses web browser 117 to access the virtual concierge shipping system homepage. In other embodiments, Customer selects the virtual concierge shipping option from a menu or button display on the display screen of client 102, for example. In yet other embodiments, Customer selects the virtual concierge shipping option using voice activation.

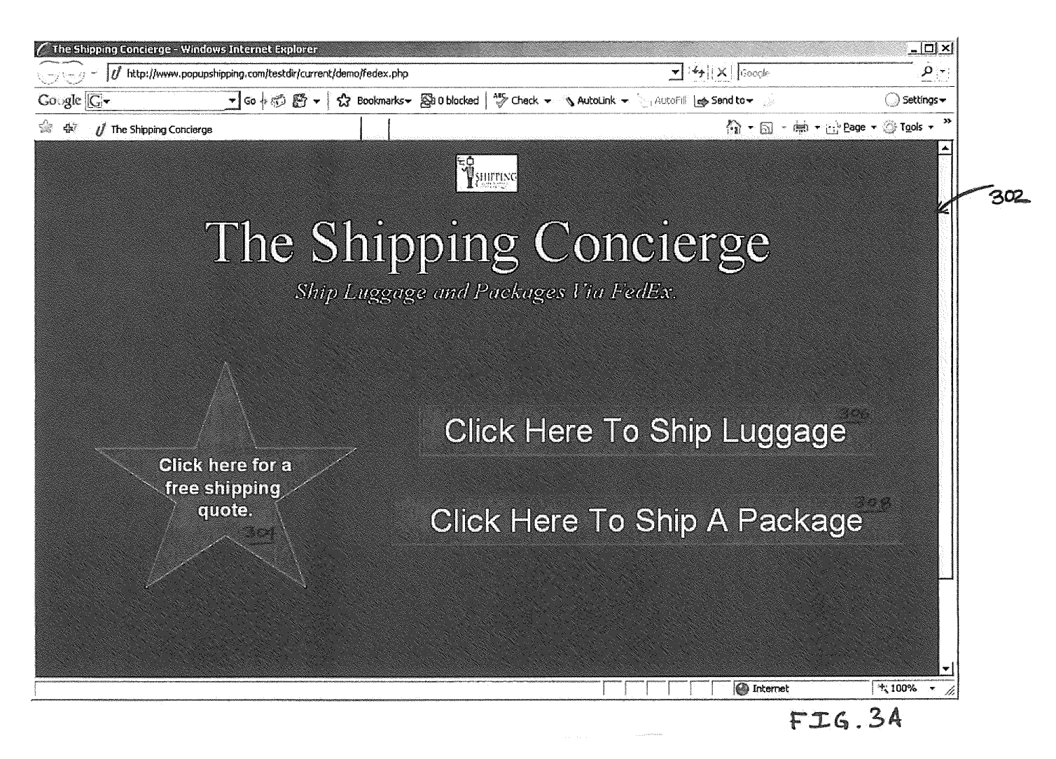

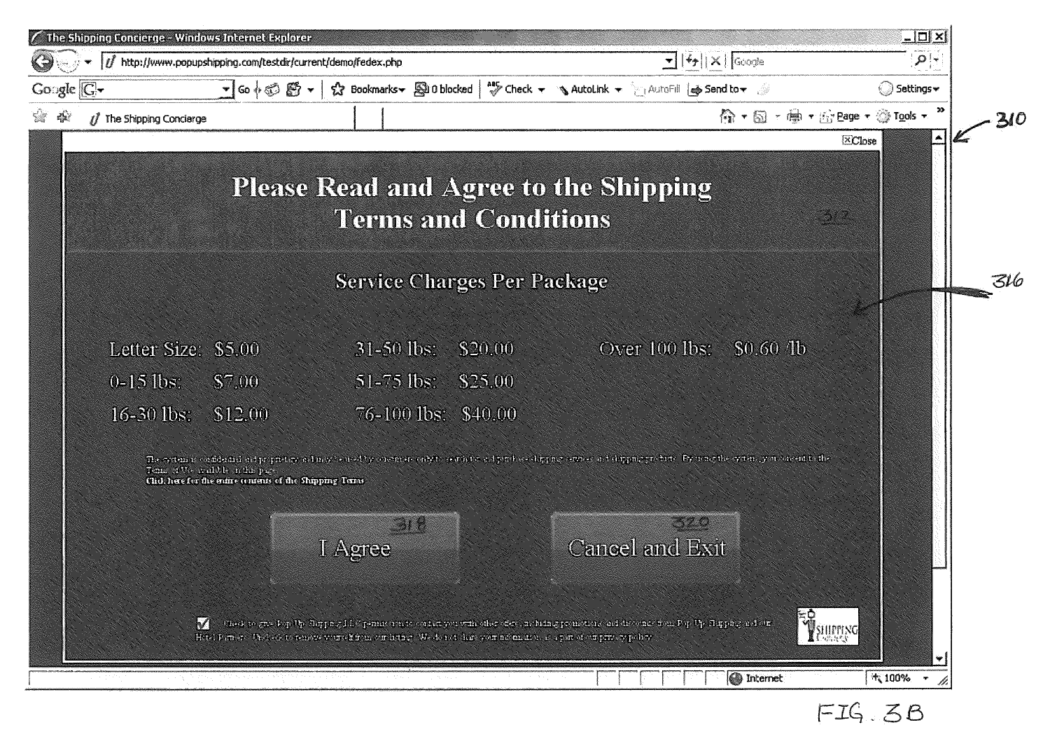

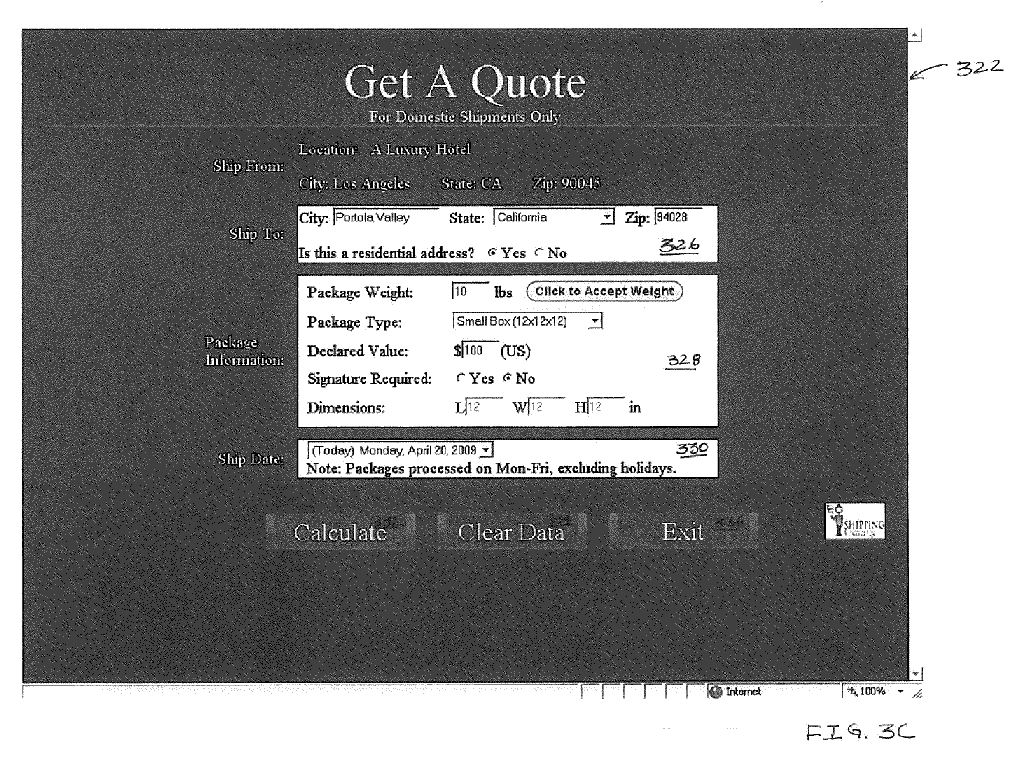

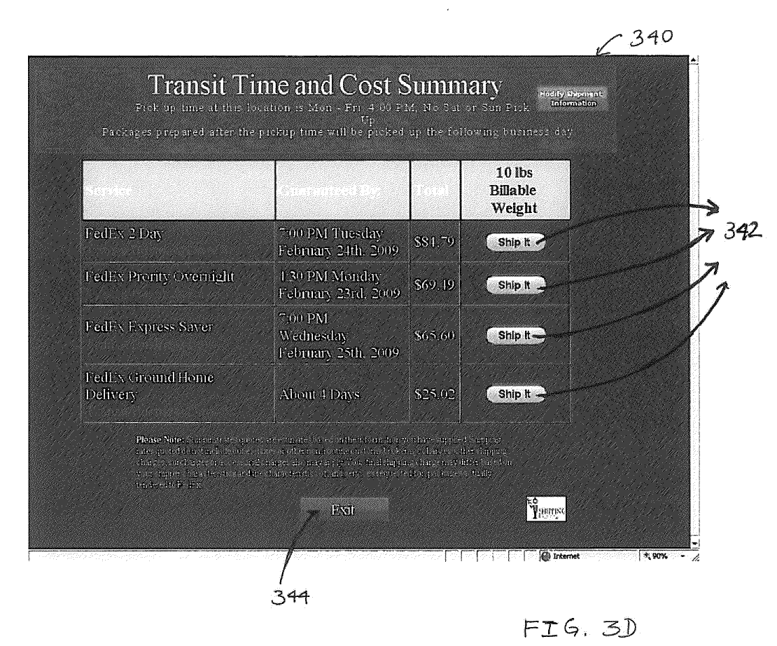

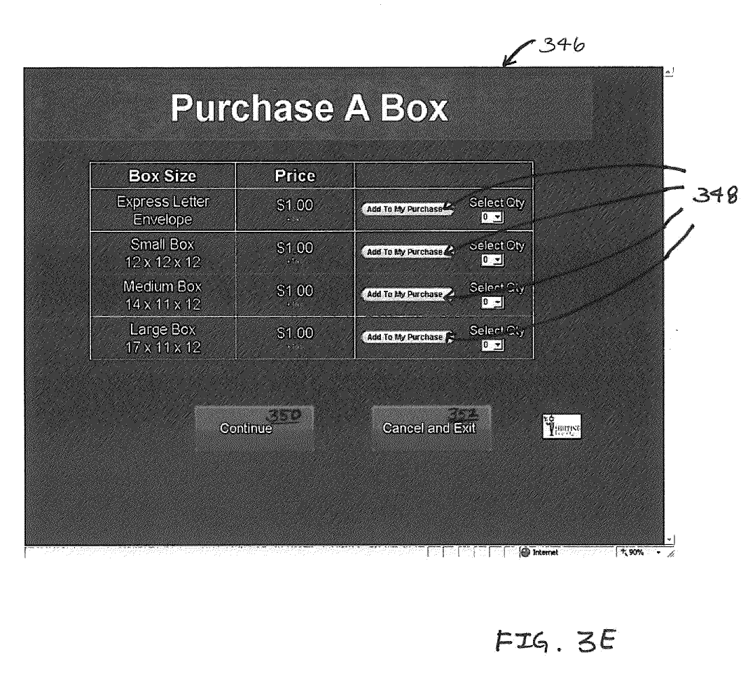

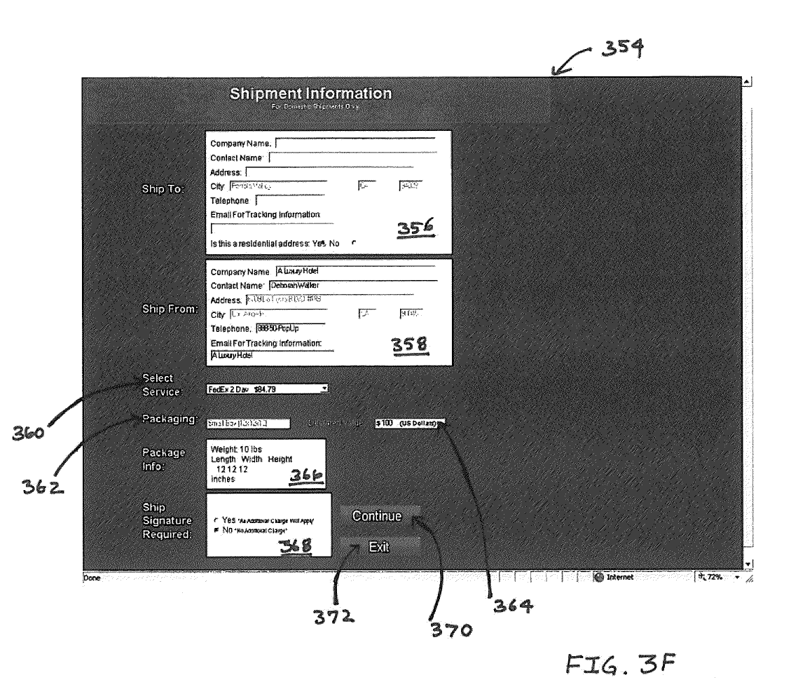

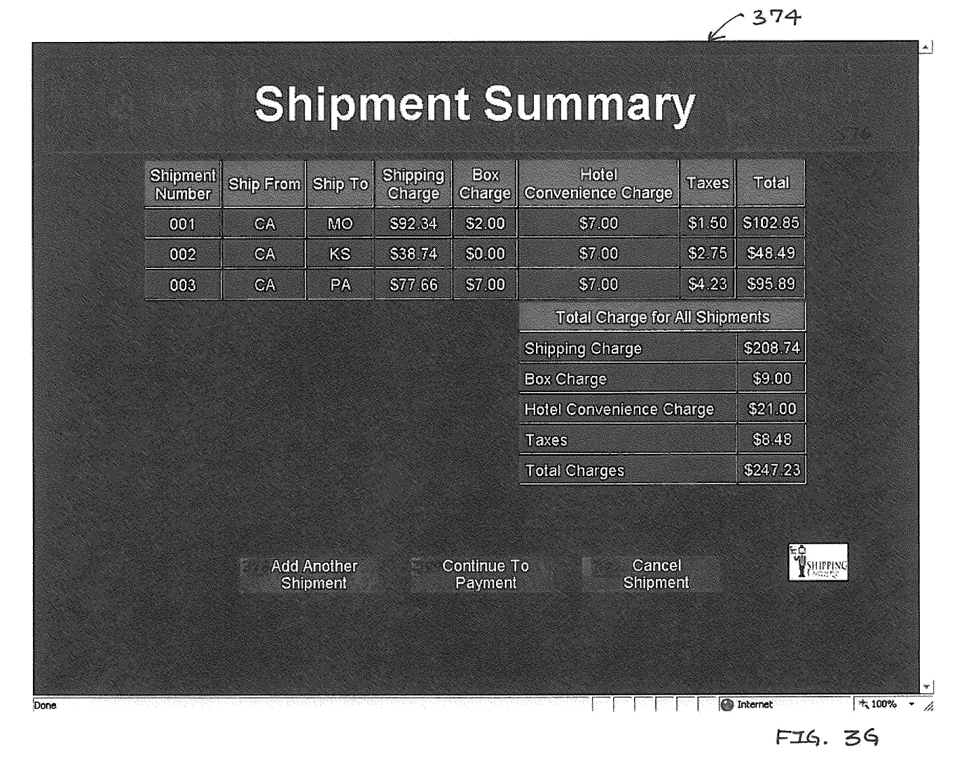

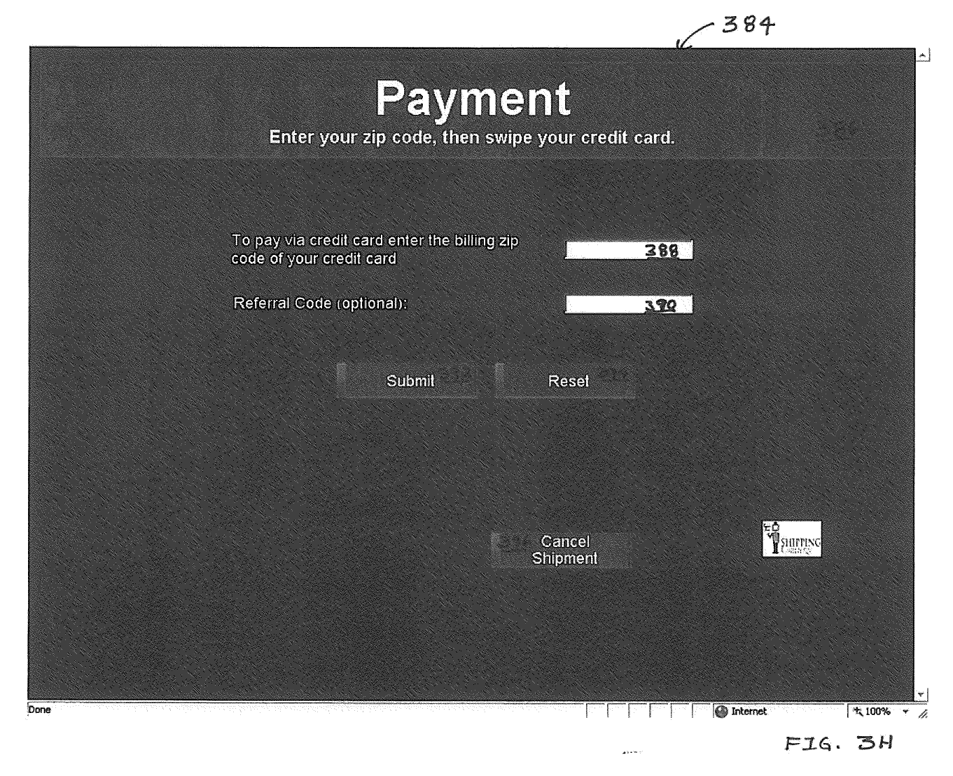

In blocks 204a, 204b of FIG. 2, an initial web page is displayed to Customer through graphical user interface 103. One embodiment of Graphical user interface 103 and related web pages are described in greater detail herein with reference to FIGS. 3A-3H. As a non-limiting example, the initial web page may offer Customer a choice to receive a shipping price quote (204a) and a choice to begin the shipping ordering process (204b). If Customer selects to receive a shipping price quote in block 204a, then in block 206, a web page is displayed to Customer requesting from Customer, shipping information such as, package destination, weight of package, preferred transit time (class of shipping service), etc. After Customer enters the requested shipping information, then in block 208, Customer is given shipping price quote based on the entered information. Customer is then returned to the initial web page where Customer can begin the shipping ordering process.

If Customer selects to begin the shipping ordering process in block 204b, then in block 209 a web page is displayed to Customer requesting from Customer, shipment information such as, Customer's choice of shipping address, “Ship To” name and address, and package weight. According to certain embodiments, Customer can weigh the package that is to be shipped on a weighing machine, such as weighing machine 109. According to certain embodiments, the weighing machine is networked to client 102 and the weight of the package is automatically entered for Customer. In other embodiments the weighing machine is a standalone machine that is located at a convenient location in close proximity to client 102 and Customer reads the weight information and manually enters the weight information on the web page.

In optional block 210, Customer is given the option to purchase packaging materials. For example, Customer is presented with a web page showing boxes and envelopes of various sizes with price information. Customer can select type of material and quantity for purchase.

After Customer enters shipment information as requested in block 209 and/or in block 210, then in block 212 Customer is given a final price quote for the services selected and or for the packaging material.

In block 214, Customer is asked to pay for the selected services and or for the packaging materials. According to some embodiments, Customer can use a credit card (or debit card or smart card, etc) acceptor that is networked to client 102 to make a payment using a credit or debit card. In other embodiments, Customer manually enters credit card (or debit card) information using graphical user interface 103. In some embodiments, Customer is given the option of using any one of various online payment options such as electronic fund transfers, and echecks, etc.

After verification and acceptance of payment, in block 216 an encoded shipping label is created based on Customer's shipment information. The encoded shipping label is printed for Customer using printer 110 that is networked to client 102, according to certain embodiments. As a non-limiting example, the encoded shipping label may include non-human readable encoded information that is specific to the shipping carrier selected by Customer. Examples of non-human readable encoded information include bar codes and two dimensional symbols. FedEx “Ground 96 Code 128” is a non-limiting example of a bar code. FedEx “Portable Data File 417” is a non-limiting example of a two dimensional symbol. Examples of encoded information include shipping carrier identification, ass of service, package number, weight information, tracking number, pickup location, recipient street address, Julian pickup date, etc. The encoded information may vary depending on the shipping carrier selected by Customer. For example, encoded information for UPS or DHL may be different from that of FedEx or of the United States Postal Service.

Customer may then affix the printed encoded label to the package or piece of luggage that is to be shipped. If Customer purchased packaging materials, then packaging materials are dispensed to Customer. For example, a dispensing machine may be used or an automatic notification is sent to hotel staff to deliver packaging materials. According to certain embodiments, the virtual concierge shipping system includes a secure drop-box where Customer can drop off packages that are ready for shipping. In other embodiments, Customer may drop off packages at convenient designated locations.

FIGS. 3A-3H are screen shots that illustrate graphical user interface 103 and concomitant sample web pages, according to certain embodiments. FIGS. 3A-3H indentifie shipping carrier as FedEx. However, the embodiments are not restricted to a particular shipping carrier. According to some embodiments, the customer may select from a plurality of shipping carriers, such as UPS, DHL, USPS, etc.

FIG. 3A shows a web page 302 that allows a customer:
to obtain shipping price quote by selecting option 304,
to ship luggage by selecting option 306, and
to ship a package by selecting option 308.

FIG. 3B shows a web page 310 that includes instructions 312 on terms and conditions, and information on service charges 316. Web page 310 allows the customer:
to agree to the terms and conditions by selecting option 318, or
to cancel and exit by selecting option 320.

FIG. 3C shows web page 322 that allows the customer to get a shipping price quote. Web page 322 allows the customer:
to enter “Ship To” information 326,
to enter “Package Information” 328,
to enter “Ship Date” 330,
to calculate a quote by selecting option 332,
to ear data by selecting option 334; and
to exit by selecting option 336.

FIG. 3D shows a web page 340 that informs the customer on transit time and gives a cost summary. Web page 340 also allows the customer:
to select a ass of service by selecting any of options 342, and
to exit by selecting option 344.

FIG. 3E shows a web page 346 that allows the customer:
to purchase packaging materials by selecting any of options 348,
to continue with the shipping order process by selecting option 350, and
to cancel and exit by selecting option 352.

FIG. 3F shows a web page 354 that allows the customer:
to enter “Ship To” information 356,
to enter “Ship From” information 358,
to select a class of service 360,
to enter packaging description information 362,
to enter a “declared value” 364 for the shipment,
to package information 366,
to select “signature requirement” option 368,
to continue with the shipping order process by selecting option 370, or
to exit by selecting option 372.

FIG. 3G shows a web page 374 that shows shipment summary information 376. Web page 374 also allows the customer:
to add another shipment by selecting option 378,
to continue to the payment page by selecting option 380, or
to cancel shipment by selecting option 382.

FIG. 3H shows a web page 384 that shows payment instructions 386. Web page 384 also allows the customer:
to enter credit card information 388,
to enter referral code 390,
to submit payment information by selecting option 392,
to reset or clear data by selecting option 394, or
to cancel shipment by selecting option 396.

It is to be noted some of the data fields in the web pages describes above may be optional. Further, the shipping service options and payment options may vary depending on the shipping carrier selected and depending on the business objectives of the business concern that is using the virtual concierge shipping system. Thus the design of graphical user interface 103 and the web pages described above may vary from implementation to implementation.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various embodiments with various modifications as are suited to the particular use contemplated.

We claim:

1. A computer-implemented method for providing a virtual concierge for shipping services, the method comprising:
providing to at least one business concern an automated self-service front-end shipping system for use by customers of the at least one business concern, for shipping packages, wherein the automated self-service front-end shipping system comprises:
a computer-implemented graphical user-interface for allowing a respective customer of the at least one business concern,
to input shipping address information,
to select a shipping carrier,
to select a class of shipping service offered by the selected shipping carrier,
to receive pricing information based on the respective customer's inputted information,
to select packaging supplies for purchase, and
to pay for the selected shipping service and for the selected packaging supplies;
creating a pre-paid encoded shipping label based on at least the respective customer's input selection of shipping carrier and class of shipping service, wherein the encoded shipping label includes non-human readable encoded information specific to the selected shipping carrier; and
enabling the respective customer to print the pre-paid encoded shipping label.

2. The computer-implemented method of claim 1, further comprising using a computer-implemented program interface to allow communication between the computer-implemented graphical user-interface and a weighing machine for automatically inputting to the computer-implemented graphical user-interface weight information of a respective package that the respective customer wishes to ship.

3. The computer-implemented method of claim 1, further comprising using a credit card payment acceptor for accepting payment by the respective customer for the selected shipping service and for the selected packaging supplies.

4. The computer-implemented method of claim 1, wherein the computer-implemented graphical user-interface includes input fields for receiving manual input by the respective customer of credit card information.

5. The computer-implemented method of claim 1, further comprising using a web-based application program that is associated with the computer-implemented graphical user-interface and with a database that stores information associated with the automated self-service front-end shipping system.

6. The computer-implemented method of claim 1, further comprising:
using a computer display for displaying the computer-implemented graphical user-interface;
using a computer device associated with the computer display; and
using an input device for allowing the respective customer to input information to the computer-implemented graphical user-interface and navigate the computer-implemented graphical user-interface.

7. The computer-implemented method of claim 6, wherein the computer device is any one of a personal digital assistant, a desktop computer, a laptop, internet kiosk, cell phone, handheld computer, and interactive TV system.

8. The computer-implemented method of claim 6, wherein the input device is one or more of a mouse, keyboard, touch screen, trackball and microphone.

9. The computer-implemented method of claim 1, further comprising communicating with other computers over a local area network.

10. The computer-implemented method of claim 1, further comprising communicating with other computers over a wide area network.

11. The computer-implemented method of claim 1, further comprising dispensing packaging supplies to the respective customer after receiving payment from the respective customer.

12. The computer-implemented method of claim 1, further comprising providing a drop-box where respective customers can drop off packages that are ready for shipping.

13. The computer-implemented method of claim 1, further comprising providing a plurality of online payment options including electronic fund transfers, credit cards, smart cards, debit cards, and echecks.

14. The computer-implemented method of claim 1, wherein the automated self-service front-end shipping system uses a wireless communication protocol.

15. The computer-implemented method of claim 1, wherein the computer-implemented graphical user-interface includes input fields for receiving manual input by the respective customer of weight information.

16. The computer-implemented method of claim 1, further comprising:
using a printer that communicates with the computer-implemented graphical interface for printing at least encoded shipping labels for the respective customer.

17. The computer-implemented method of claim 16, wherein the printer is co-located in close proximity with a computer device that is displaying the computer-implemented graphical interface.

18. The computer-implemented method of claim 1, further comprising:
using a weighing machine that communicates with the computer-implemented graphical user interface for inputting to the computer-implemented graphical user interface weight information of a respective package that is weighed on the weighing machine.

19. The computer-implemented method of claim 18, wherein the weighing machine is co-located in close proximity with a computer device that is displaying the computer-implemented graphical interface.

20. The computer-implemented method of claim 3, wherein the credit card payment acceptor is a computer network component of the automated self service shipping service.
